(19) United States
(12) Patent Application Publication
(10) Pub. No.: US 2008/0057743 A1
(43) Pub. Date: Mar. 6, 2008

(54) Printed circuit board connection structure, high-frequency unit, method of connecting printed circuit boards, and method of manufacturing high-frequency unit

(75) Inventor: Eri Sogabe, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/878,895

(22) Filed: Jul. 27, 2007

(30) Foreign Application Priority Data
Aug. 31, 2006 (JP) 2006-235561(P)

(51) Int. Cl. H01R 12/00

(52) U.S. Cl. 439/65; 29/600; 333/32; 439/66

(57) ABSTRACT

A printed circuit board connection structure allowing facilitated connection of a plurality of printed circuit boards and cost reduction, a high-frequency unit, a method of connecting printed circuit boards, and a method of manufacturing a high-frequency unit are provided. A printed circuit board connection structure includes a plurality of printed circuit boards, having a connection portion pattern, formed on a surface, and at least one printed circuit board out of the plurality of printed circuit boards, is arranged with respect to another printed circuit board such that the connection portion patterns, are opposed to each other. In addition, the opposing connection portion patterns, are connected to each other by means of a reflow-hardened solder.

This nonprovisional application is based on Japanese Patent Application No. 2006-235561 filed with the Japan Patent Office on Aug. 31, 2006, the entire contents of which are hereby incorporated by reference.

### FIELD OF THE INVENTION

The present invention relates to a printed circuit board connection structure, a high-frequency unit, a method of connecting printed circuit boards, and a method of manufacturing a high-frequency unit, and relates to a printed circuit board connection structure, for example, formed by arranging two or more printed circuit boards on top of each other, a high-frequency unit, a method of connecting printed circuit boards, and a method of manufacturing a high-frequency unit.

### DESCRIPTION OF THE BACKGROUND ART

As shown in FIG. 15, a high-frequency unit 100 contained in a digital terrestrial broadcasting reception tuner, an analog terrestrial broadcasting reception tuner, a satellite broadcasting reception tuner, and the like has conventionally included boards 101, 102 and 103, and a housing 104 storing boards 101, 102 and 103, and the like inside.

Specifically, boards 102 and 103 such as a digital terrestrial portion board and a satellite broadcast portion board are arranged on a single board 101. Here, a printed circuit board adapted to a most complicated circuit among circuits integrated on single board 101 should be selected for use as two or more printed circuit boards in such a high-frequency unit. Accordingly, an expensive printed circuit board is used in spite of the fact that a simple circuit is formed, which leads to cost increase. In addition, as performance of each circuit is changed, characteristic thereof cannot sufficiently be obtained either. Moreover, when two or more boards are connected for use, the boards are connected to each other by means of an external part such as a connector or a pin terminal.

As to a connection method using an external part, Japanese Patent Laying-Open No. 2001-7512 (Document 1) discloses a method of electrically connecting a plurality of microminiaturized circuit boards to each other. As shown in FIG. 16, Document 1 discloses connection of patterns 111a and 112l a formed on two respective boards 111 and 112 by means of a connector 113 for wire bonding or re-bonding.

With such a method of electrically connecting a plurality of microminiaturized circuit boards to each other disclosed in Document 1, however, the connector which is an external part is used for connection and connection should individually be made at each point of connection between the external part and the board. In addition, individual connection should be made separately also when a part to be mounted (hereinafter, referred to as “mounted part”) is connected onto the board. Therefore, the connection step and the mount step are complicated. Moreover, the external part leads to expensive cost.

### SUMMARY OF THE INVENTION

From the foregoing, the present invention was made to solve the above-described problems. An object of the present invention is to provide a printed circuit board connection structure allowing facilitated connection of a plurality of printed circuit boards and cost reduction, a high-frequency unit, a method of connecting printed circuit boards, and a method of manufacturing a high-frequency unit.

A printed circuit board connection structure according to the present invention includes a plurality of printed circuit boards having a connection portion pattern formed on a surface. At least one printed circuit board out of the plurality of printed circuit boards is arranged with respect to an other printed circuit board such that the connection portion patterns are opposed to each other. The opposing connection portion patterns are connected to each other by means of a reflow-hardened solder.

A method of connecting printed circuit boards according to the present invention includes the steps of preparing a plurality of printed circuit boards having a connection portion pattern formed on a surface; arranging at least one printed circuit board out of the plurality of printed circuit boards and an other printed circuit board such that the connection portion patterns are opposed to each other; arranging a solder on a surface of one of the opposing connection portion patterns; and connecting the plurality of printed circuit boards to each other by reflow-hardening the solder.

According to the printed circuit board connection structure and the method of connecting printed circuit boards of the present invention, a plurality of printed circuit boards are connected to each other by means of the reflow-hardened solder, without using an external part such as a connector or a pin terminal. Therefore, by reflow-hardening the solder once after the solder is arranged on the printed circuit board, the plurality of printed circuit boards can be connected in a single step. Thus, the plurality of printed circuit boards can readily be connected. In addition, as the solder is more inexpensive than the external part, cost reduction can be achieved.

Preferably, the printed circuit board connection structure further includes a mounted part connected by means of the solder onto the connection portion pattern of at least one printed circuit board.

In the method of connecting the printed circuit boards, preferably, in the connecting step, a mounted part is connected by means of the solder onto the connection portion pattern of at least one printed circuit board.

By thus reflow-hardening the solder in connecting the plurality of printed circuit boards, connection of the plurality of printed circuit boards to each other and connection of the printed circuit board and the mounted part can be made in a single step. Therefore, the mounted part can readily be connected.

In the printed circuit board connection structure, preferably, in at least one printed circuit board, a through hole extending from a surface opposed to the solder on the connection portion pattern to a surface opposite to where the connection portion pattern is located is formed.

In the method of connecting the printed circuit boards, preferably, in the preparing step, a through hole extending from one surface to an other surface is formed in at least one printed circuit board.

Excessive solder left at the time of reflow-hardening of the solder is thus allowed to escape into the through hole. Therefore, the plurality of printed circuit boards can further readily be connected.

In the printed circuit board connection structure, preferably, the connection portion pattern where the through hole is formed is formed at an end portion of the printed circuit board, and the through hole is implemented as an end-face through hole.

In the method of connecting the printed circuit boards, preferably, in the preparing step, the connection portion pattern is formed at an end portion of the printed circuit board, and in forming the through hole, an end-face through hole is formed.

Excessive solder left at the time of reflow-hardening of the solder is thus allowed to escape into the end-face through hole. Therefore, the plurality of printed circuit boards can further readily be connected.

In the printed circuit board connection structure, preferably, the connection portion pattern is formed at an end portion of the printed circuit board, and the printed circuit board has a two-dimensional shape with at least one projecting portion.

In the method of connecting the printed circuit boards, preferably, in the preparing step, the connection portion pattern is formed at an end portion of the printed circuit board, and the printed circuit board is formed to have a two-dimensional shape with at least one projecting portion.

A state of connection between the plurality of printed circuit boards and the solder can thus readily be checked. Therefore, connection of the plurality of printed circuit boards can be ensured.

In the printed circuit board connection structure, preferably, at least one printed circuit board is implemented by a single-sided board.

In the method of connecting the printed circuit boards, preferably, in the preparing step, at least one single-sided board is prepared as the printed circuit board.

Thus, cost reduction can be achieved. In addition, the printed circuit board having a conventional circuit (pattern) can be used without change.

In the printed circuit board connection structure, preferably, at least one printed circuit board is implemented by a double-sided board.

In the method of connecting the printed circuit boards, preferably, at least one double-sided board is prepared as the printed circuit board.

Thus, the printed circuit board having a conventional pattern can be used without change.

In the printed circuit board connection structure, preferably, three or more printed circuit boards are prepared as the plurality of printed circuit boards, and a multiple-connection printed circuit board directly connected by means of the solder to two or more other printed circuit boards among the plurality of printed circuit boards is directly connected by means of the solder to the two or more other printed circuit boards at its single surface.

In the method of connecting the printed circuit boards, preferably, in the preparing step, three or more printed circuit boards are prepared, and in the step of arranging the printed circuit boards, the printed circuit boards are arranged such that the connection portion pattern on a single surface of at least one printed circuit board among the plurality of printed circuit boards is opposed to the connection portion patterns of two or more other printed circuit boards.

Thus, when three or more printed circuit boards are connected, total thickness can be suppressed.

In the printed circuit board connection structure, preferably, three or more printed circuit boards are prepared as the plurality of printed circuit boards, and at least one multiple-connection printed circuit board directly connected by means of the solder to two or more other printed circuit boards among the plurality of printed circuit boards is implemented by the double-sided board, and the multiple-connection printed circuit board is directly connected by means of the solder to the two or more other printed circuit boards at opposing surfaces.

In the method of connecting the printed circuit boards, preferably, in the preparing step, three or more printed circuit boards are prepared, and in the step of arranging the printed circuit boards, the printed circuit boards are arranged such that the connection portion patterns on opposing surfaces of at least one printed circuit board among the plurality of printed circuit boards are opposed to the connection portion patterns of two or more other printed circuit boards respectively.

Thus, the size as a whole can be made smaller, and therefore, three or more printed circuit boards can be connected in a desired shape.

A high-frequency unit according to the present invention includes the printed circuit board connection structure described above, and a housing in which the plurality of printed circuit boards are arranged.

A method of manufacturing a high-frequency unit according to the present invention includes the steps of: connecting the plurality of printed circuit boards to each other by using the method of connecting printed circuit boards described above; and arranging the plurality of printed circuit boards in a housing.

According to the high-frequency unit and the method of manufacturing the high-frequency unit of the present invention, the plurality of printed circuit boards can readily be connected by using a solder more inexpensive than the external part. Therefore, a high-frequency unit such as a multiple-function tuner utilizing a characteristic of a pattern of the printed circuit board can readily be manufactured with lower cost.

In the high-frequency unit, preferably, the plurality of printed circuit boards has a penetration hole in a portion where the printed circuit boards overlap with each other and where no connection portion pattern is formed, at such a position that penetration holes continue to each other, the housing has a board penetrating portion, and the plurality of printed circuit boards and the housing are connected to each other by penetration of the board penetrating portion through the penetration hole.

Preferably, the method of manufacturing a high-frequency unit further includes the steps of forming a penetration hole in the plurality of printed circuit boards, in a portion where the printed circuit boards overlap with each other and where no connection portion pattern is formed, at such a position that penetration holes continue to each other (penetration hole forming step); forming a board penetrating portion in the housing (penetrating portion forming step); and connecting the plurality of printed circuit boards and the housing to each other by inserting the board penetrating portion in the penetration hole.

As the plurality of printed circuit boards and the housing are thus fixed in a stable manner, a high-frequency unit of high performance can be obtained.

In the high-frequency unit, preferably, the penetration hole is formed in a ground pattern.

In the method of manufacturing a high-frequency unit, preferably, in the step of forming a penetration hole (penetration hole forming step), a ground pattern is formed in a portion where the penetration hole is formed.

Thus, an effect of grounding the plurality of printed circuit boards and the housing can be improved. Therefore, interference of each circuit can be prevented and leakage of noise of each circuit can be prevented.

In the high-frequency unit, preferably, the board penetrating portion has a protrusion for fixation at an end portion.

In the method of manufacturing a high-frequency unit, preferably, in the step of forming a board penetrating portion (penetrating portion forming step), a protrusion for fixation is formed at an end portion of the board penetrating portion.

As the plurality of printed circuit boards and the housing are thus fixed in a further stable manner, a high-frequency unit of higher performance can be obtained.

According to the printed circuit board connection structure, the high-frequency unit, the method of connecting printed circuit boards, and the method of manufacturing a high-frequency unit of the present invention, connection of a plurality of printed circuit boards is facilitated and cost reduction can be achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic side view showing a printed circuit board connection structure in a first embodiment of the present invention.

FIG. 2 is a schematic perspective view showing a printed circuit board in the first embodiment of the present invention.

FIG. 3 is a schematic plan view showing the printed circuit board in the first embodiment of the present invention.

FIG. 4 is a schematic side view showing the printed circuit board connection structure of a single-sided board in the first embodiment of the present invention.

FIG. 5 is a schematic side view showing the printed circuit board connection structure of a double-sided board in the first embodiment of the present invention.

FIG. 6 is a schematic side view showing the printed circuit board connection structure having a through hole formed in the first embodiment of the present invention.

FIG. 7 is a schematic side view showing the printed circuit board connection structure having an end-face through hole formed in the first embodiment of the present invention.

FIG. 8 is a flowchart showing a method of connecting printed circuit boards in the first embodiment of the present invention.

FIG. 9 is a schematic side view showing a printed circuit board connection structure in a second embodiment of the present invention.

FIG. 10 is a schematic side view showing a printed circuit board connection structure in a variation of the second embodiment of the present invention.

FIG. 11 is a schematic plan view of a printed circuit board constituting a high-frequency unit in a third embodiment of the present invention.

FIG. 12 is a schematic cross-sectional view of the high-frequency unit in the third embodiment of the present invention.

FIG. 13 is a schematic plan view of another printed circuit board constituting the high-frequency unit in the third embodiment of the present invention.

FIG. 14 is another schematic cross-sectional view of the high-frequency unit in the third embodiment of the present invention.

FIG. 15 is a schematic top view of a conventional high-frequency unit.

FIG. 16 is a schematic side view showing a connection method in Document 1.

### DESCRIPTION OF THE PREFERRED EMBODIMENTS

An embodiment of the present invention will be described hereinafter with reference to the drawings. In the drawings, the same or corresponding elements have the same reference characters allotted, and description thereof will not be repeated.

### First Embodiment

A printed circuit board connection structure in a first embodiment of the present invention will be described with reference to FIGS. 1 to 7.

As shown in FIG. 1, a printed circuit board connection structure 10 in the first embodiment includes a plurality of printed circuit boards 11 and 12 having connection portion patterns 11a and 12a formed on respective surfaces. At least one printed circuit board 11 out of the plurality of printed circuit boards 11 and 12 is arranged with respect to another printed circuit board 12 such that connection portion patterns 11a and 12a are opposed to each other. Opposing connection portion patterns 11a and 12a are connected by means of a reflow-hardened solder 13.

Printed circuit board connection structure 10 in the first embodiment is a connection structure of two printed circuit boards 11 and 12. Printed circuit board connection structure 10 includes two printed circuit boards 11 and 12 and solder 13. Solder 13 is formed on connection portion pattern 11a, 12a at an end portion of the plurality of printed circuit boards 11 and 12 such that printed circuit boards 11 and 12 overlap with each other. Namely, printed circuit boards 11 and 12 are arranged in a manner opposed to each other, with solder 13 lying therebetween.

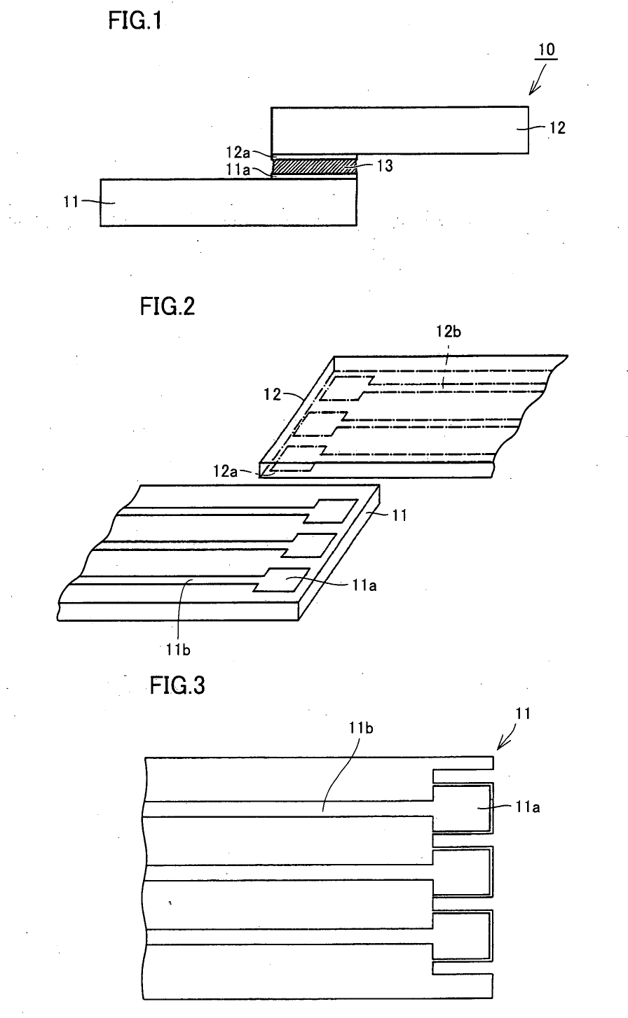

Specifically, as shown in FIG. 2, printed circuit boards 11 and 12 have connection portion patterns 11a and 12a formed on respective surfaces. So long as the connection portion pattern is conductive, the connection portion pattern is not particularly limited, however, the connection portion pattern is made, for example, of a thin metal film. In addition, in the first embodiment, connection portion patterns 11a and 12a are formed at respective end portions of printed circuit boards 11 and 12. It is noted that connection portion pattern 11a, 12a may be formed at a plurality of portions of printed circuit board 11, 12.

In addition, as shown in FIG. 3, preferably, connection portion pattern 11a is formed at the end portion of printed circuit board 11, and printed circuit board 11 has a two-dimensional shape with at least one projecting portion. Preferably, a plurality of projecting portions are formed. If a plurality of projecting portions are formed, one end portion or opposing end portions of printed circuit board 11 is/are in a shape like a comb along the connection portion pattern. In addition, if a plurality of projecting portions are formed, the projecting portions may be different in projection length, or adjacent projecting portions different in projection length may partially continue to each other to form a shape like stairs, or projecting portions different in projection length may be separate from each other.

Moreover, preferably, a mounted part (not shown) connected by means of solder 13 is further included on connection portion pattern 11a, 12a of at least one printed circuit board 11, 12. The mounted part is not particularly restricted, and desired number of arbitrary parts may be arranged at desired portion(s).

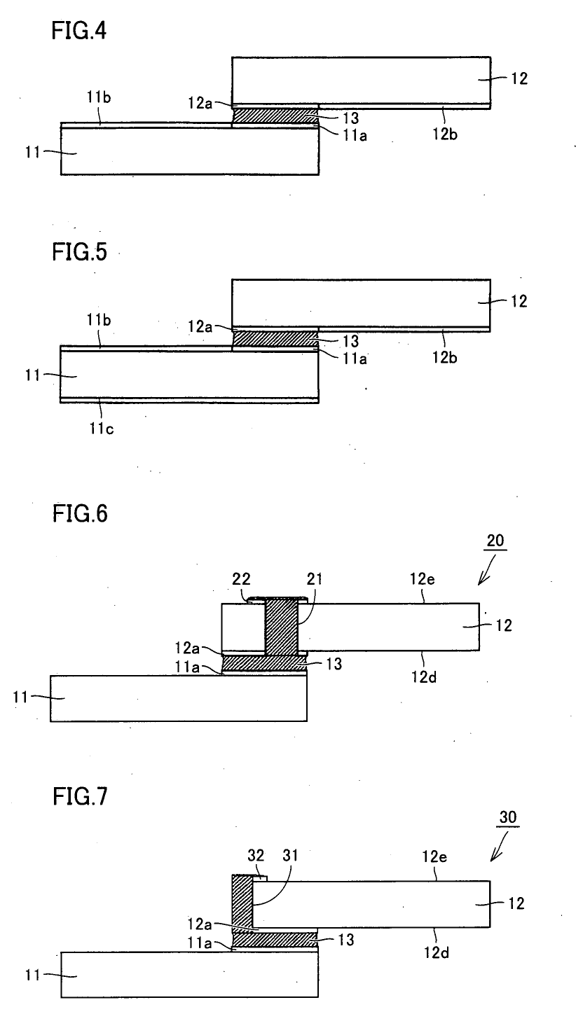

In addition, as shown in FIG. 4, printed circuit boards 11 and 12 may be a single-sided board having patterns 11b and 12b only on their one surfaces, respectively. Alternatively, as shown in FIG. 5, printed circuit board 11 may be a double-sided board having patterns 11b and 11c on respective opposing surfaces, and printed circuit board 12 may be a single-sided board. Alternatively, printed circuit boards 11 and 12 may be a double-sided board (not shown). Alternatively, printed circuit boards 11 and 12 may be a multi-layer board (not shown) obtained by stacking an insulator and a pattern.

Here, the single-sided board refers to a board having a pattern (circuit) formed only on one surface thereof, and the double-sided board refers to a board having patterns (circuits) formed on respective opposing surfaces thereof The pattern includes connection portion patterns 11a and 12a. The pattern refers to a conductor film formed to have a prescribed two-dimensional shape for configuring a circuit.

Though solder 13 is not particularly limited, for example, LFM-48W TM-BP (Sn—Ag—Cu) manufactured by Nihon Almit Co., Ltd., TLF-204-57F2 (Sn—Ag—Cu) manufactured by Tamura Corporation, NP303-GM655-GK (Sn—Ag—Cu) manufactured by Nihon Genma Mfg. Co., Ltd., or an equivalent product may suitably be employed.

As shown in FIG. 6, preferably, in at least one printed circuit board 12, a through hole 21 extending from a surface 12d opposed to solder 13 on connection portion pattern 12a to a surface 12e opposite to where connection portion pattern 12a is located is formed. Namely, through hole 21 is formed in printed circuit board 12 for connection to a portion where solder 13 is present. In a printed circuit board connection structure 20 in this example, through hole 21 is partially or entirely filled with solder 13. If through hole 21 is entirely filled with solder 13, solder 13 may be arranged also on surface 12e opposite to where connection portion pattern 12a is located. If solder 13 is arranged on surface 12e, a pattern 22 is preferably provided on surface 12e connected to through hole 21. If pattern 22 is provided on surface 12e, pattern 22 and solder 13 are electrically connected to each other. Therefore, electrical connection is more stable.

Alternatively, as shown in FIG. 7, preferably, connection portion pattern 12a having a through hole formed is formed at an end portion of printed circuit board 12, and the through hole is implemented as an end-face through hole 31. At least a part of the end portion of one printed circuit board 12 opposed to another printed circuit board 11 is opened and connected to connection portion pattern 12a. In a printed circuit board connection structure 30 in this example, end-face through hole 31 is partially or entirely filled with solder 13. If end-face through hole 31 is entirely filled with solder 13, solder 13 may be arranged also on surface 12e opposite to where connection portion pattern 12a is located. If solder 13 is arranged also on surface 12e, a pattern 32 is preferably provided on surface 12e connected to end-face through hole 31. If pattern 32 is provided on surface 12e, pattern 32 and solder 13 are electrically connected to each other. Therefore, electrical connection is more stable.

A land portion implemented, for example, by a semicircular thin metal film pattern is formed in end-face through hole 31. Here, connection portion pattern 12a and the land portion in end-face through hole 31 are electrically connected to each other.

Description has been given with reference to FIGS. 6 and 7 where through hole 21 or end-face through hole 31 is formed in single printed circuit board 12, however, the present invention is not particularly limited to such a structure. Preferably, any of through hole 21 and end-face through hole 31 is formed in at least one printed circuit board 12.

A method of connecting printed circuit boards according to the present invention will now be described with reference to FIGS. 1 to 8.

As shown in FIGS. 1, 2 and 8, initially, the step of preparing a plurality of printed circuit boards 11 and 12 having connection portion patterns 11a and 12a formed on respective surfaces (S10) is performed. In the preparing step (S10), for example, printed circuit boards 11 and 12 shown in FIG. 2 are prepared.

In the preparing step (S10), as shown in FIG. 3, preferably, connection portion patterns 11a and 12a are formed at respective end portions of printed circuit boards 11 and 12, and printed circuit boards 11 and 12 are formed to have a two-dimensional shape with at least one projecting portion.

In the preparing step (S10), any board may be employed as printed circuit board 11, 12, and for example, an already-existing printed circuit board having a pattern formed may be employed without change. As shown in FIG. 4, preferably, at least one single-sided board is prepared as printed circuit board 11, 12. Alternatively, as shown in FIG. 5, preferably, at least one double-sided board is prepared as printed circuit board 11, 12.

In addition, as shown in FIG. 6, in the preparing step (S10), preferably, through hole 21 extending from one surface 12d to another surface 12e is formed in at least one printed circuit board 12. Alternatively, as shown in FIG. 7, connection portion pattern 12a is formed at the end portion of printed circuit board 12, and in forming the through hole, end-face through hole 31 is preferably formed.

Here, if through hole 21 or end-face through hole 31 is formed in printed circuit board 12 as shown in FIG. 6 or 7, pattern 22, 32 connected to through hole 21 or end-face through hole 31 is preferably formed on surface 12e opposite to surface 12d where connection portion pattern 12a connected to solder 13 is formed.

Thereafter, as shown in FIG. 2, the step of arranging at least one printed circuit board 11 out of the plurality of printed circuit boards 11 and 12 and another printed circuit board 12 such that connection portion patterns 11a and 12a are opposed to each other (S20) is performed.

When a mounted part (not shown) is connected to printed circuit board 11, 12, in the step of arranging the printed circuit boards (S20), preferably, the mounted part is arranged on connection portion pattern 11a, 12a of printed circuit board 11, 12. Here, the mounted part may be arranged on a pattern including connection portion pattern 11a, 12a.

Thereafter, the step of arranging the solder on the surface of one of opposing connection portion patterns 11a and 12a (S30) is performed. In the step of arranging the solder (S30), a paste solder, or what is called cream solder, is applied or printed onto at least one connection portion pattern (for example, connection portion pattern 11a). A material for the solder is not particularly limited, however, LFM-48W TM-HP (Sn—Ag—Cu) manufactured by Nihon Almit Co., Ltd., TLF-204-57F2 (Sn—Ag—Cu) manufactured by Tamura Corporation, NP303-GM655-GK (Sn—Ag—Cu) manufactured by Nihon Genma Mfg. Co., Ltd., or an equivalent product described above is preferably employed.

When the mounted part is connected to printed circuit board 11, 12, the paste solder is applied or printed onto connection portion pattern 11a, 12a to be connected to the mounted part arranged in the step of arranging the printed circuit boards.

Thereafter, the step of connecting the plurality of printed circuit boards 11 and 12 to each other by reflow-hardening solder 13 (S40) is performed. In this step (S40), for example, printed circuit boards 11 and 12 on which the solder is arranged are directly heated so as to melt the solder. The solder is thus molten and then hardened. The plurality of printed circuit boards 11 and 12 are thus connected to each other by means of solder 13.

If printed circuit board 12 having through hole 21 or end-face through hole 31 formed is prepared in the preparing step (S10), excessive solder 13 in the connecting step (S40) flows through through hole 21 or end-face through hole 31, as shown in FIG. 6 or 7. Further excessive solder 13 that flows through through hole 21 or end-face through hole 31 flows over pattern 22, 32 connected to through hole 21 or end-face through hole 31.

When the mounted part is connected to printed circuit board 11, 12, in the connecting step (S40), preferably, the mounted part (not-shown) is connected by means of solder 13 onto connection portion pattern 11a, 12a of at least one printed circuit board 11, 12. In this step, the solder for connecting printed circuit boards 11 and 12 to each other, that is arranged on the surface of connection portion pattern 11a, 12a, and the solder for connecting the mounted part are simultaneously reflow-hardened. Thus, connection of the mounted part and connection of printed circuit boards 11 and 12 to each other can simultaneously be made.

Thereafter, whether or not printed circuit boards 11 and 12 have been connected to each other by means of reflow-hardened solder 13 is checked. If connection portion patterns 11a and 12a are formed at respective end portions of printed circuit boards 11 and 12 and printed circuit boards 11 and 12 have a two-dimensional shape with at least one projecting portion, a state of connection can readily be checked.

If it is confirmed in the checking step that the plurality of printed circuit boards 11 and 12 have been connected to each other by means of solder 13, printed circuit board connection structures 10, 20 and 30 in the first embodiment can be obtained. On the other hand, if it is confirmed in the checking step that the plurality of printed circuit boards 11 and 12 have not been connected to each other by means of solder 13, the step of arranging the solder (S30), the connecting step (S40) and the checking step are similarly performed.

As described above, printed circuit board connection structures 10, 20 and 30 in the first embodiment of the present invention include the plurality of printed circuit boards 11 and 12 having connection portion patterns 11a and 12a formed on respective surfaces, at least one printed circuit board 11 out of the plurality of printed circuit boards 11 and 12 is arranged with respect to another printed circuit board 12 such that connection portion patterns 11a and 12a are opposed to each other, and opposing connection portion patterns 11a and 12a are connected to each other by means of reflow-hardened solder 13. The plurality of printed circuit boards 11 and 12 are connected to each other by means of reflow-hardened solder 13, without using an external part such as a connector or a pin terminal. Therefore, by reflow-hardening solder 13 once, the plurality of printed circuit boards can simultaneously be connected. Thus, printed circuit board connection structures 10, 20 and 30 allowing facilitated connection can be obtained. In addition, as solder 13 is more inexpensive than the external part, printed circuit board connection structures 10, 20 and 30 with lower cost can be obtained. In addition, as a range of choice of a printed circuit board to be connected is wide, characteristics of each printed circuit board can sufficiently be obtained without changing performance of each pattern.

Preferably, printed circuit board connection structures 10, 20 and 30 further include the mounted part connected by means of solder 13 onto connection portion pattern 12a of at least one printed circuit board 12. Thus, connection between the plurality of printed circuit boards 11 and 12 and connection between printed circuit board 11, 12 and the mounted part can simultaneously be made by using reflow-hardened solder 13. Thus, printed circuit board 11, 12 can include the mounted part that can readily be connected.

In printed circuit board connection structures 10, 20 and 30, preferably, through hole 21 extending from surface 12d opposed to solder 13 on connection portion pattern 12a to surface 12e opposite to where connection portion pattern 12a is located is formed in at least one printed circuit board 12. Thus, excessive solder left at the time of reflow-hardening of solder 13 is allowed to escape into through hole 21. Therefore, printed circuit board connection structures 10, 20 and 30 allowing further facilitated connection can be obtained.

In printed circuit board connection structures 10, 20 and 30, preferably, connection portion pattern 12a where through hole 21 is formed is formed at the end portion of printed circuit board 12, and the through hole is implemented as end-face through hole 31. Thus, excessive solder left at the time of reflow-hardening of solder 13 is allowed to escape into the end-face through hole. Therefore, printed circuit board connection structures 10, 20 and 30 allowing further facilitated connection can be obtained.

In printed circuit board connection structures 10, 20 and 30, preferably, connection portion patterns 11a and 12a are formed at respective end portions of printed circuit boards 11 and 12, and printed circuit boards 11 and 12 have a two-dimensional shape with at least one projecting portion. Thus, a state of connection between the plurality of printed circuit boards and the solder can readily be checked. Therefore, printed circuit board connection structures 10, 20 and 30 ensuring connection of the plurality of printed circuit boards to each other can be obtained.

In printed circuit board connection structures 10, 20 and 30, preferably, at least one printed circuit board 11, 12 is implemented by a single-sided board. Thus, cost reduction can be achieved. In addition, the printed circuit board having a conventional pattern can be used without change.

In printed circuit board connection structures 10, 20 and 30, preferably, at least one printed circuit board 11, 12 is implemented by a double-sided board. Thus, the printed circuit board having a conventional pattern can be used without change.

The method of connecting the printed circuit boards in the first embodiment of the present invention includes the steps of preparing the plurality of printed circuit boards 11 and 12 having connection portion patterns 11a and 12a formed on respective surfaces (S10); arranging at least one printed circuit board 11 out of the plurality of printed circuit boards and another printed circuit board 12 such that connection portion patterns 11a and 12a are opposed to each other (S20); arranging the solder on the surface of one of opposing connection portion patterns 11a and 12a (S30); and connecting the plurality of printed circuit boards 11 and 12 to each other by reflow-hardening the solder (S40). Thus, the plurality of printed circuit boards can be connected to each other at a time through reflow-hardening of once, after the solder is arranged on connection portion pattern 11a, 12a, without using an external part such as a connector or a pin terminal. Accordingly, the plurality of printed circuit boards can simultaneously be connected. Thus, the plurality of printed circuit boards can readily be connected. In addition, as the plurality of printed circuit boards can be connected by means of solder 13 that is more inexpensive than the external part, cost reduction can be achieved. As it has conventionally been necessary to select a printed circuit board adapted to a complicated pattern, performance of each pattern has been changed and a characteristic of each printed circuit board could not sufficiently be obtained. According to the method of connecting the printed circuit boards in the first embodiment of the present invention, however, as a range of choice of the printed circuit board is wide, it is not necessary to change the printed circuit board even if a printed circuit board having a complicated pattern formed is connected, and the characteristic of each printed circuit board can be utilized. In addition, it has conventionally been necessary to change a printed circuit board having a simple pattern formed to a printed circuit board having a complicated pattern formed. In the first embodiment, however, a printed circuit board having a simple pattern formed can be used as it is, and therefore, cost reduction can be achieved.

According to the method of connecting the printed circuit boards, preferably, in the connecting step (S40), the mounted part is connected by means of solder 13 onto connection portion pattern 11a, 12a of at least one printed circuit board 11, 12. Thus, by reflow-hardening the solder in connecting the plurality of printed circuit boards 11 and 12, connection of the plurality of printed circuit boards to each other and connection between the printed circuit board and the mounted part can be made at a time. Thus, the mounted part can readily be connected.

In addition, it has conventionally been necessary to make a connection at each point of connection by using the external part, however, according to the method of connecting the printed circuit boards in the first embodiment, the plurality of printed circuit boards and the mounted part can be connected by reflow-hardening the solder once. Therefore, the number of steps for connecting the mounted part can be decreased.

According to the method of connecting the printed circuit boards, preferably, in the preparing step (S10), through hole 21 extending from one surface 12d to another surface 12e is formed in at least one printed circuit board 12. Thus, excessive solder left at the time of reflow-hardening of the solder is allowed to escape into through hole 21. Therefore, an amount of solder 13 on connection portion pattern 11a, 12a can be adjusted. Therefore, the plurality of printed circuit boards 11 and 12 can further readily and reliably be connected to each other.

According to the method of connecting the printed circuit boards, preferably, in the preparing step (S10), connection portion pattern 12a is formed at the end portion of printed circuit board 12, and in forming the through hole, end-face through hole 31 is formed. Thus, excessive solder 13 left at the time of reflow-hardening of the solder is allowed to escape into end-face through hole 31. Therefore, an amount of solder 13 on connection portion pattern 11a, 12a can be adjusted. Therefore, the plurality of printed circuit boards 11 and 12 can further readily be connected.

According to the method of connecting the printed circuit boards, preferably, in the preparing step (S10), connection portion patterns 11a and 12a are formed at respective end portions of printed circuit boards 11 and 12, and printed circuit boards 11 and 12 are formed to have a two-dimensional shape with at least one projecting portion. Thus, a state of connection between the plurality of printed circuit boards 11, 12 and solder 13 can readily be checked. Therefore, connection of the plurality of printed circuit boards can be ensured.

According to the method of connecting the printed circuit boards, preferably, in the preparing step (S10), at least one single-sided board is prepared as printed circuit board 11, 12. Thus, cost reduction can be achieved. In addition, the printed circuit board having a conventional pattern can be used without change.

According to the method of connecting the printed circuit boards, preferably, at least one double-sided board is prepared as printed circuit board 11, 12. Thus, the printed circuit board having a conventional pattern can be used without change.

### Second Embodiment

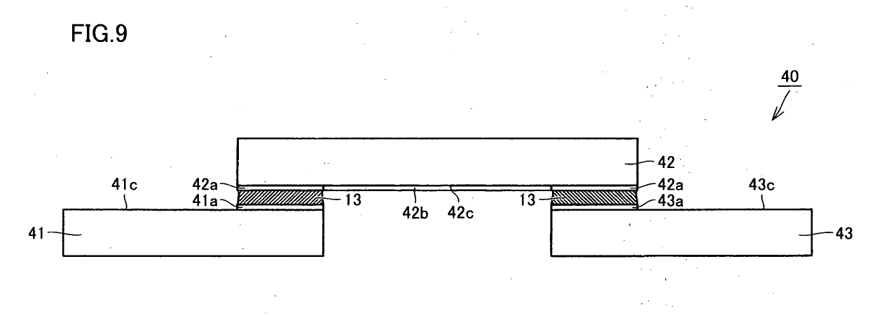

A printed circuit board connection structure in a second embodiment of the present invention will be described with reference to FIG. 9. The printed circuit board connection structure in the second embodiment is different from printed circuit board connection structures 10, 20 and 30 in the first embodiment shown in FIGS. 1, 6 and 7 only in that it is the connection structure of three printed circuit boards.

As shown in FIG. 9, in a printed circuit board connection structure 40, a multiple-connection printed circuit board 42 directly connected by means of solder 13 to two or more other printed circuit boards 41 and 43 among a plurality of printed circuit boards 41, 42 and 43 is directly connected to two or more other printed circuit boards 41 and 43 by means of solder 13 at a single surface 42c thereof Specifically, multiple-connection printed circuit board 42 is a single-sided board having a pattern 42b formed, and pattern 42b has connection portion pattern 42a at opposing end portions. Printed circuit boards 41 and 43 have connection portion patterns 41a and 43a formed on surfaces 41c and 43c at one end portions respectively. Opposing connection portion patterns 41a and 42a are connected to each other and opposing connection portion patterns 43a and 42a are connected to each other by means of reflow-hardened solder 13.

In printed circuit board connection structure 40, printed circuit boards 41 to 43 are arranged such that directions in which printed circuit boards 41 to 43 face solder 13 are alternate, and printed circuit boards 41 to 43 are connected such that they are arranged on alternate sides.

Though multiple-connection printed circuit board 42 is implemented as a single-sided board in FIG. 9, the present invention is not particularly limited as such. Multiple-connection printed circuit board 42 may have connection portion pattern 42a formed only at its opposing end portions, and it may be a double-sided board.

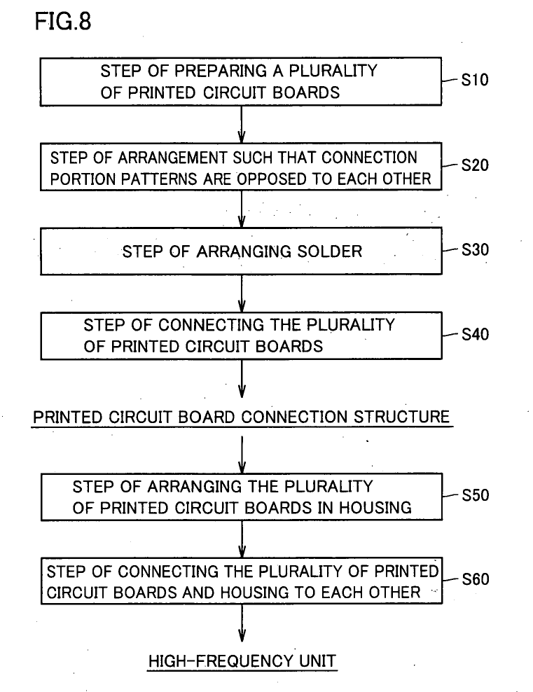

A method of connecting printed circuit boards according to the second embodiment of the present invention will now be described with reference to FIGS. 8 and 9. The method of connecting printed circuit boards in the second embodiment is basically the same as that in the first embodiment, and it is different only in the preparing step (S10) and the step of arranging the printed circuit boards (S20).

According to the second embodiment, in the preparing step (S10), three or more printed circuit boards 41, 42 and 43 are prepared. Specifically, as shown in FIG. 9, two printed circuit boards 41 and 43 having connection portion patterns 41a and 43a formed at one end portions of at least one surfaces 41c and 43c respectively are prepared. In addition, one printed circuit board 42 having connection portion pattern 42a formed at opposing end portions of at least one surface is prepared.

The second embodiment is the same as the first embodiment in that, preferably, a printed circuit board having a through hole or an end-face through hole formed is prepared, a printed circuit board of which end portion is formed to have a two-dimensional shape with a projecting portion is prepared, and a printed circuit board implemented by a single-sided board or a double-sided board is prepared in the preparing step (S10).

In the step of arranging the printed circuit boards (S20), the printed circuit boards are arranged such that connection portion pattern 42a on single surface 42c of at least one printed circuit board (multiple-connection printed circuit board 42) among the plurality of printed circuit boards 41, 42 and 43 is opposed to connection portion patterns 41a and 43a of two or more other printed circuit boards 41 and 43.

The second embodiment is the same as the first embodiment in that the mounted part is preferably arranged as appropriate on connection portion pattern 41a, 42a, 43a of printed circuit boards 41, 42, 43 in the step of arranging the printed circuit boards (S20).

As the step of arranging the solder (S30) and the connecting step (S40) are the same as in the first embodiment, description thereof will not be repeated. It is noted that the plurality of printed circuit boards 41, 42 and 43 and the mounted part as necessary can be connected by once reflow-hardening the solder that is arranged in the step of arranging the solder (S30).

By performing the above-described steps (S10 to S40), printed circuit board connection structure 40 according to the second embodiment of the present invention shown in FIG. 9 can be obtained.

As described above, according to printed circuit board connection structure 40 in the second embodiment of the present invention, three or more printed circuit boards 41, 42 and 43 are prepared as the plurality of printed circuit boards, and multiple-connection printed circuit board 42 directly connected by means of solder 13 to two or more other printed circuit boards 41 and 43 among the plurality of printed circuit boards 41, 42 and 43 is directly connected to two or more other printed circuit boards 41 and 43 by means of solder 13 at single surface 42c thereof. Thus, when three or more printed circuit boards are connected to each other, printed circuit board connection structure 40 having a suppressed thickness as a whole can be obtained.

According to the method of connecting the printed circuit boards in the second embodiment of the present invention, in the preparing step (S10), three or more printed circuit boards 41, 42 and 43 are prepared, and in the step of arranging the printed circuit boards (S20), the printed circuit boards are arranged such that connection portion pattern 42a on single surface 42c of at least one printed circuit board among the plurality of printed circuit boards 41, 42 and 43 is opposed to connection portion patterns 41a and 43a of two or more other printed circuit boards 41 and 43. The three or more printed circuit boards can thus be connected at a time (a single step). Therefore, connection of the printed circuit boards can be facilitated. In addition, as connection has conventionally been made at each point of connection by using the external part, the number of steps for connecting three or more printed circuit boards can be decreased in the second embodiment. Moreover, connection of the printed circuit boards with a thickness as a whole being suppressed can be made.

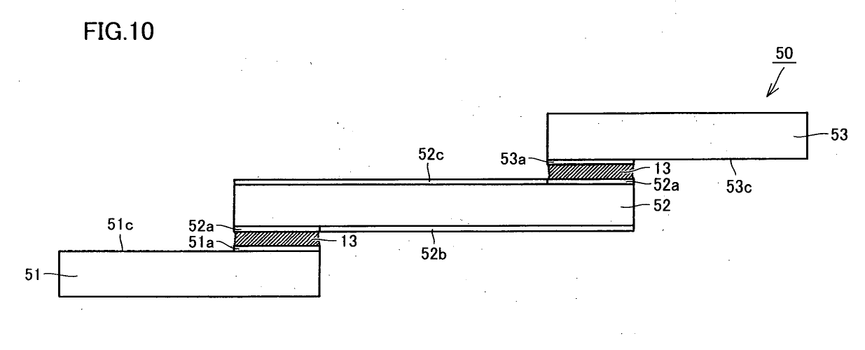

A variation of the printed circuit board connection structure in the second embodiment will now be described with reference to FIG. 10.

As shown in FIG. 10, in a printed circuit board connection structure 50, a multiple-connection printed circuit board 52 directly connected by means of solder 13 to two or more other printed circuit boards 51 and 53 among a plurality of printed circuit boards 51, 52 and 53 is implemented by a double-sided board, and the multiple-connection printed circuit board is directly connected to two or more other printed circuit boards 51 and 53 by means of solder 13 at opposing surfaces thereof.

Specifically, multiple-connection printed circuit board 52 has patterns 52b and 52c formed on opposing surfaces, and one end portions of patterns 52b and 52c serve as connection portion pattern 52a. Opposing connection portion patterns 51a and 52a are connected to each other and opposing connection portion patterns 53a and 52a are connected to each other by means of reflow-hardened solder 13.

In printed circuit board connection structure 50, connection portion patterns 51a to 53a of printed circuit boards 51 to 53 are connected such that they are successively stacked.

Though multiple-connection printed circuit board 52 is implemented by a double-sided board in FIG. 10, multiple-connection printed circuit board 52 is not particularly limited thereto, so long as the connection portion pattern is formed at one end portion on one surface and the other end portion of the other surface.

A method of connecting the printed circuit boards in the variation of the second embodiment will now be described with reference to FIGS. 8 and 10. The method of connecting the printed circuit boards in the variation is basically the same as in the second embodiment, and it is different from that in the second embodiment only in the preparing step (S10) and the step of arranging the printed circuit boards (S20).

According to the variation of the second embodiment, in the preparing step (S10), three or more printed circuit boards 51, 52 and 53 are prepared. Specifically, as shown in FIG. 10, two printed circuit boards 51 and 53 having connection portion patterns 51a and 53a formed at one end portions of at least one surfaces 51c and 53c respectively are prepared. In addition, multiple-connection printed circuit board 52 implemented by a double-sided board having connection portion pattern 52a formed at the end portion of opposing surfaces is prepared.

In the step of arranging the printed circuit boards (S20), the printed circuit boards are arranged such that connection portion patterns 52a on opposing surfaces of one double-sided board (multiple-connection printed circuit board 52) among the plurality of printed circuit boards 51, 52 and 53 are opposed to connection portion patterns 51a and 53a of two or more other printed circuit boards respectively.

As the step of arranging the solder (S30) and the connecting step (S40) are the same as in the first embodiment, description thereof will not be repeated.

By performing the above-described steps (S10 to S40), printed circuit board connection structure 50 in the variation of the second embodiment shown in FIG. 10 can be obtained.

It is noted that printed circuit board connection structures 10, 20 and 30 in the first embodiment, printed circuit board connection structure 40 in the second embodiment, and printed circuit board connection structure 50 in the variation of the second embodiment are examples of the printed circuit board connection structure according to the present invention, and the present invention is not particularly limited to the connection structure of two or three printed circuit boards, so long as a plurality of printed circuit boards are connected in the connection structure. Four or more printed circuit boards may be connected.

Alternatively, a connection structure of a plurality of printed circuit boards may be different. For example, printed circuit board connection structures 10, 20 and 30 in the first embodiment, printed circuit board connection structure 40 in the second embodiment, printed circuit board connection structure 50 in the variation of the second embodiment, and the like may be combined to implement a desired structure of a plurality of printed circuit boards.

As described above, according to printed circuit board connection structure 50 in the variation of the second embodiment of the present invention, three or more printed circuit boards 51, 52 and 53 are prepared as the plurality of printed circuit boards, at least one multiple-connection printed circuit board 52 directly connected by means of solder 13 to two or more other printed circuit boards 51 and 53 among the plurality of printed circuit boards 51, 52 and 53 is implemented by a double-sided board, and multiple-connection printed circuit board 52 is directly connected to two or more other printed circuit boards 51 and 53 by means of solder 13 at opposing surfaces thereof. Thus, printed circuit board connection structure 50 of a smaller size as a whole can be obtained.

According to the method of connecting the printed circuit boards in the variation of the second embodiment of the present invention, in the preparing step (S10), three or more printed circuit boards 51, 52 and 53 are prepared, and in the step of arranging the printed circuit boards (S20), the printed circuit boards are arranged such that connection portion patterns 52a on opposing surfaces of at least one double-sided board (multiple-connection printed circuit board 52) among the plurality of printed circuit boards 51, 52 and 53 are opposed to connection portion patterns 51a and 53a of two or more other printed circuit boards 51 and 53 respectively. Thus, connection of the printed circuit boards can readily be made. In addition, the number of steps for connecting three or more printed circuit boards can be decreased. Moreover, connection of a smaller size as a whole can be made.

### Third Embodiment

A high-frequency unit in a third embodiment of the present invention will be described with reference to FIGS. 11 to 15. A high-frequency unit 60 in the third embodiment of the present invention includes printed circuit board connection structure 10 to 50 in the first or second embodiment and a housing in which a plurality of printed circuit boards are arranged.

The high-frequency unit in the third embodiment includes boards 101 to 103 constituting conventional high-frequency unit 100 shown in FIG. 15, frame-shaped housing 104 incorporating boards 101 to 103 inside, and a connector 105 arranged at a peripheral wall of housing 104.

In boards 101 to 103 constituting the high-frequency unit in the third embodiment, for example, a digital terrestrial portion board (board 102) and a satellite broadcast portion board (board 103) are formed on the printed circuit board (board 101), and the printed circuit board is connected to the digital terrestrial portion board and the satellite broadcast portion board, for example, by means of reflow-hardened solder 13 in the first embodiment.

The housing (shield case) constituting the high-frequency unit in the third embodiment includes, for example, a wall plate on each side assembled along an outer periphery of the printed circuit board, each partition plate partitioning a space on the printed circuit board into a plurality of blocks, and a lid plate and a bottom plate provided over and under the wall plate on each side and covering the printed circuit board from above and below. Though the wall plate on each side, each partition plate, the lid plate, and the bottom plate are not particularly limited, each of these portions is formed of a magnetic material, metal or the like, and serve as magnetic shielding and electrostatic shielding.

Specifically, as shown in FIG. 11, the plurality of printed circuit boards 11 have a penetration hole 61 in a portion where the printed circuit boards overlap with each other and where connection portion pattern 11a is not formed, at such a position that penetration holes continue to each other. Penetration hole 61 is implemented, for example, by a through hole or a non-through hole formed in a printed circuit board.

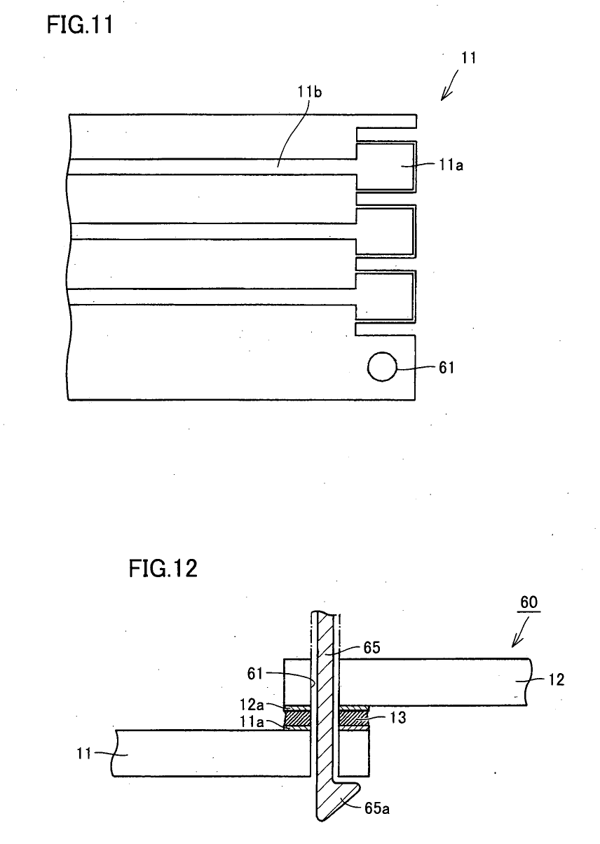

In addition, as shown in FIG. 12, the housing has a board penetrating portion 65. As a result of penetration of board penetrating portion 65 through penetration hole 61, the plurality of printed circuit boards 11 and 12 and the housing are connected to each other.

Board penetrating portion 65 preferably has a protrusion 65a for fixation at an end portion. Protrusion 65a for fixation protrudes in a manner in contact with printed circuit board 11 on the end portion side. Though protrusion 65a for fixation is not particularly limited, for example, it may have such a shape that its tip end is folded back.

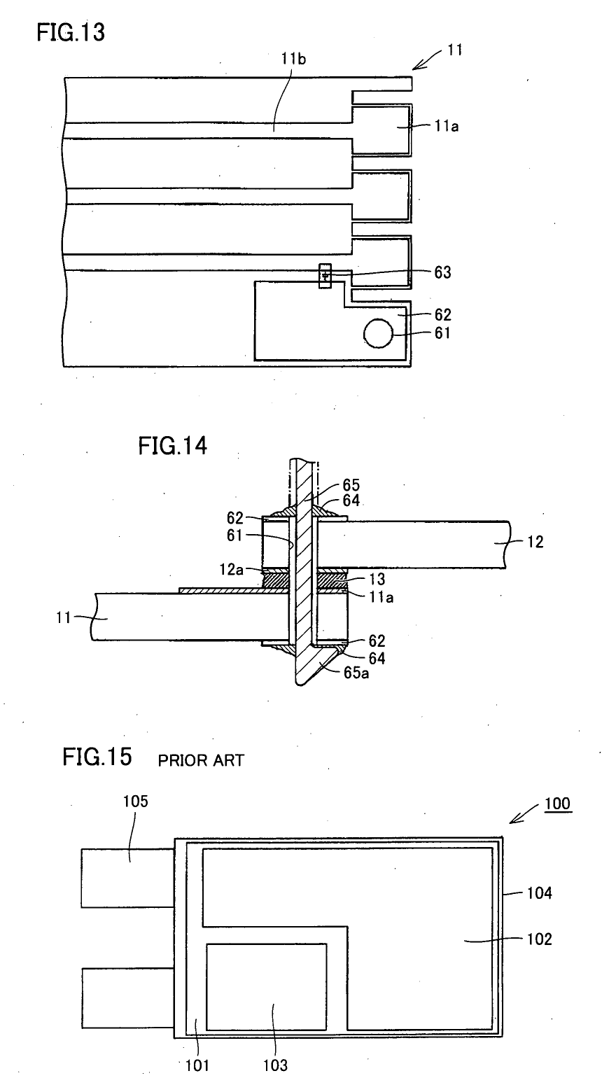

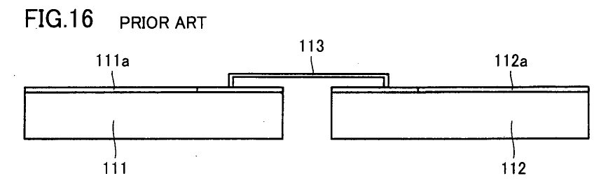

Moreover, as shown in FIG. 13, penetration hole 61 is preferably formed in a ground pattern 62 on printed circuit board 11. In addition, as shown in FIG. 14, ground pattern 62 is preferably connected such that it is arranged on a surface opposite to the surface where printed circuit board 11, 12 is opposed to solder 13. Here, board penetrating portion 65 of the housing and ground pattern 62 are connected by means of the solder. It is noted that the ground pattern refers to a conductive film for grounding, that is formed to have a prescribed two-dimensional shape for configuring a circuit.

A method of manufacturing the high-frequency unit in the third embodiment will now be described with reference to FIGS. 8 and 11 to 14.

Initially, as shown in FIG. 8, the step of connecting the plurality of printed circuit boards with the method of connecting the printed circuit boards (S10 to S40) in the first or second embodiment is performed. Thus, the plurality of printed circuit boards can be connected by means of reflowed solder 13.

Thereafter, the step of arranging the plurality of printed circuit boards in the housing (S50) is performed. By performing this step (S50), the high-frequency unit including the plurality of printed circuit boards and the housing can be manufactured.

Thereafter, preferably, the step of connecting the plurality of printed circuit boards and the housing to each other (S60) is performed. In this step (S60), for example, the following step is performed. As shown in FIG. 11, the penetration hole forming step of forming penetration hole 61 in the plurality of printed circuit boards 11, in a portion where the printed circuit boards overlap with each other and where no connection portion pattern 11a is formed, at such a position that penetration holes 61 continue to each other is performed. In the penetration hole forming step, as shown in FIG. 13, ground pattern 62 is preferably formed in a portion where penetration hole 61 is formed. In the case that ground pattern 62 is formed, a chip 63 is preferably connected by means of reflowed solder 13 such that chip 63 lies astride pattern 11b and ground pattern 62.

Then, as shown in FIG. 12, the penetrating portion forming step of forming board penetrating portion 65 in the housing is performed. In the penetrating portion forming step, protrusion 65a for fixation is formed at the end portion of board penetrating portion 65. Protrusion 65a for fixation is formed, for example, by bending one end portion of board penetrating portion 65.

Then, the step of connecting the plurality of printed circuit boards 11 and 12 and the housing to each other by inserting board penetrating portion 65 in penetration hole 61 is performed.

Thereafter, as shown in FIG. 14, the plurality of printed circuit boards 11 and 12, the surface opposite to the surface where printed circuit board 11, 12 is opposed to the solder (ground pattern 62 in the third embodiment), and board penetrating portion 65 are connected by means of a solder 64. In this step, for example, solder 64 obtained by reflow-hardening the paste solder is used for connection.

By performing the above-described steps (S10 to S60), high-frequency unit 60 in the third embodiment can be manufactured.

As described above, high-frequency unit 60 according to the third embodiment of the present invention includes printed circuit board connection structure 10, 20, 30, 40, 50 in the first or second embodiment and the housing in which the plurality of printed circuit boards are arranged. High-frequency unit 60 in the third embodiment includes printed circuit board connection structure 10, 20, 30, 40, 50 allowing facilitated connection and cost reduction. Therefore, a high-frequency unit such as a multiple-function tuner utilizing a characteristic of a pattern of the printed circuit board, that allows facilitated connection of the plurality of printed circuit boards and cost reduction, can be obtained.

In addition, high-frequency unit 60 may include a printed circuit board connection structure including all of a connection structure in which double-sided boards are connected to each other, a connection structure in which single-sided boards are connected to each other, and a connection structure in which a double-sided board and a single-sided board are connected to each other, Accordingly, conventionally separate tuners can be manufactured as a multiple-function tuner such as the high-frequency unit in the third embodiment of the present invention. Even if a multiple-function tuner is manufactured, the printed circuit board can be utilized without change. Therefore, manufacturing is facilitated and the cost can be lowered.

Moreover, as a desired printed circuit board connection structure is obtained by combining conventional printed circuit boards, a high-frequency unit maintaining high performance can be obtained in a shorter time period.

In high-frequency unit 60, preferably, the plurality of printed circuit boards have penetration hole 61 in a portion where the printed circuit boards overlap with each other and where no connection portion pattern is formed, at such a position that penetration holes 61 continue to each other, the housing has board penetrating portion 65, and the plurality of printed circuit boards and the housing are connected to each other by penetration of board penetrating portion 65 through penetration hole 61. Thus, fixation of the plurality of printed circuit boards and the housing can be stabilized. Therefore, the high-frequency unit of high performance is obtained.

In high-frequency unit 60, preferably, penetration hole 61 is formed in ground pattern 62. Thus, an effect of grounding the printed circuit board where ground pattern 62 is formed and the housing can be improved. Therefore, interference of each circuit can be prevented and leakage of noise of each circuit can be prevented.

In high-frequency unit 60, preferably, board penetrating portion 65 has protrusion 65a for fixation at the end portion. Thus, fixation of the plurality of printed circuit boards and the housing can be stabilized. Therefore, the high-frequency unit of high performance is obtained.

The method of manufacturing high-frequency unit 60 in the third embodiment of the present invention includes the steps of connecting the plurality of printed circuit boards with the method of connecting the printed circuit boards (S10 to S40) in the first or second embodiment; and arranging the plurality of printed circuit boards inside the housing (S50). Thus, the plurality of printed circuit boards can be connected by means of reflow-hardened solder 13 that is more inexpensive than the external part, in a facilitated manner and in the decreased number of required steps. Therefore, the high-frequency unit such as a multiple-function tuner utilizing the characteristic of the pattern of the printed circuit board can readily be manufactured with lower cost.

In addition, as any of connection of the double-sided boards to each other, connection of the single-sided boards to each other, and connection of the double-sided board and the single-sided board to each other is made, conventionally separate tuners can be manufactured as a multiple-function tuner such as the high-frequency unit in the third embodiment of the present invention. In addition, even if a multiple-function tuner is manufactured, the multiple-function tuner can be manufactured without changing the printed circuit board. Therefore, manufacturing is facilitated and the cost can be lowered.

Moreover, as desired printed circuit boards can be connected by combining conventional methods of manufacturing the printed circuit boards, a high-frequency unit maintaining high performance can be manufactured in a shorter time period.

The method of manufacturing high-frequency unit 60 preferably includes the penetration hole forming step of forming penetration hole 61 in the plurality of printed circuit boards, in a portion where the printed circuit boards overlap with each other and where no connection portion pattern is formed, at such a position that penetration holes 61 continue to each other; the penetrating portion forming step of forming board penetrating portion 65 in the housing; and the step of connecting the plurality of printed circuit boards and the housing to each other by inserting board penetrating portion 65 in penetration hole 61. Thus, as the plurality of printed circuit boards and the housing are fixed in a stable manner, a high-frequency unit of high performance can be obtained.

In the method of manufacturing high-frequency unit 60, preferably, in the penetration hole forming step, ground pattern 62 is formed in the portion where penetration hole 61 is formed. Thus, an effect of grounding the printed circuit board and the housing can be improved. Therefore, interference of each circuit can be prevented and leakage of noise of each circuit can be prevented.

In the method of manufacturing high-frequency unit 60, preferably, in the penetrating portion forming step, protrusion 65a for fixation is formed at the end portion of board penetrating portion 65. Thus, as the plurality of printed circuit boards and the housing are fixed in a further stable manner, a high-frequency unit of higher performance can be obtained.

According to the printed circuit board connection structure of the present invention, the plurality of printed circuit boards can readily be connected and cost reduction can be achieved. Therefore, the present invention is suitably employed in a high-frequency unit contained in high-frequency equipment such as a digital terrestrial broadcasting reception tuner or an analog terrestrial broadcasting reception tuner, a satellite broadcasting reception tuner, and the like incorporating various electronics, or a printed circuit board connection structure for such a high-frequency unit.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A printed circuit board connection structure comprising a plurality of printed circuit boards having a connection portion pattern formed on a surface;
at least one printed circuit board out of said plurality of printed circuit boards being arranged with respect to an other printed circuit board such that said connection portion patterns are opposed to each other; and
opposing said connection portion patterns are connected to each other by means of a reflow-hardened solder.

2. The printed circuit board connection structure according to claim 1, further comprising a mounted part connected by means of said solder onto said connection portion pattern of said at least one printed circuit board.

3. The printed circuit board connection structure according to claim 1, wherein
in said at least one printed circuit board, a through hole extending from a surface opposed to said solder on said connection portion pattern to a surface opposite to where said connection portion pattern is located is formed.

4. The printed circuit board connection structure according to claim 3, wherein
said connection portion pattern where said through hole is formed is formed at an end portion of said printed circuit board, and
said through hole is an end-face through hole.

5. The printed circuit board connection structure according to claim 1, wherein
said connection portion pattern is formed at an end portion of said printed circuit board, and
said printed circuit board has a two-dimensional shape with at least one projecting portion.

6. The printed circuit board connection structure according to claim 1, wherein
said at least one printed circuit board is a single-sided board.

7. The printed circuit board connection structure according to claim 1, wherein
said at least one printed circuit board is a double-sided board.

8. The printed circuit board connection structure according to claim 1, wherein
three or more printed circuit boards are prepared as said plurality of printed circuit boards, and
a multiple-connection printed circuit board directly connected by means of said solder to two or more other said printed circuit boards among said plurality of printed circuit boards is directly connected by means of said solder to said two or more other printed circuit boards at its single surface.

9. The printed circuit board connection structure according to claim 7, wherein
three or more printed circuit boards are prepared as said plurality of printed circuit boards, and
at least one multiple-connection printed circuit board directly connected by means of said solder to two or more other said printed circuit boards among said plurality of printed circuit boards is said double-sided board, and said multiple-connection printed circuit board is directly connected by means of said solder to said two or more other printed circuit boards at opposing surfaces.

10. A high-frequency unit comprising:
the printed circuit board connection structure according to claim 1; and
a housing in which said plurality of printed circuit boards are arranged.

11. The high-frequency unit according to claim 10, wherein
said plurality of printed circuit boards has a penetration hole in a portion where the printed circuit boards overlap with each other and where no said connection portion pattern is formed, at such a position that penetration holes continue to each other,
said housing has a board penetrating portion, and
said plurality of printed circuit boards and said housing are connected to each other by penetration of said board penetrating portion through said penetration hole.

12. The high-frequency unit according to claim 11, wherein
said penetration hole is formed in a ground pattern.

13. The high-frequency unit according to claim 11, wherein
said board penetrating portion has a protrusion for fixation at an end portion.

14. A method of connecting printed circuit boards, comprising the steps of:
preparing a plurality of printed circuit boards having a connection portion pattern formed on a surface;
arranging at least one printed circuit board out of said plurality of printed circuit boards and an other printed circuit board such that said connection portion patterns are opposed to each other;
arranging a solder on a surface of one of opposing said connection portion patterns; and
connecting said plurality of printed circuit boards to each other by reflow-hardening said solder.

15. The method of connecting printed circuit boards according to claim 14, wherein
in said connecting step, a mounted part is connected by means of said solder onto said connection portion pattern of said at least one printed circuit board.

16. The method of connecting printed circuit boards according to claim 14, wherein
in said preparing step, a through hole extending from one surface to an other surface is formed in said at least one printed circuit board.

17. The method of connecting printed circuit boards according to claim 16, wherein
in said preparing step, said connection portion pattern is formed at an end portion of said printed circuit board, and
in forming said through hole, an end-face through hole is formed.

18. The method of connecting printed circuit boards according to claim 14, wherein
in said preparing step, said connection portion pattern is formed at an end portion of said printed circuit board, and
said printed circuit board is formed to have a two-dimensional shape with at least one projecting portion.

19. The method of connecting printed circuit boards according to claim 14, wherein
in said preparing step, at least one single-sided board is prepared as said printed circuit board.

20. The method of connecting printed circuit boards according to claim 14, wherein
in said preparing step, at least one double-sided board is prepared as said printed circuit board.

21. The method of connecting printed circuit boards according to claim 14, wherein
in said preparing step, three or more said printed circuit boards are prepared, and
in said step of arranging printed circuit boards, the printed circuit boards are arranged such that said connection portion pattern on a single surface of said at least one printed circuit board among said plurality of printed circuit boards is opposed to said connection portion patterns of two or more other said printed circuit boards.

22. The method of connecting printed circuit boards according to claim 20, wherein
in said preparing step, three or more said printed circuit boards are prepared, and
in said step of arranging printed circuit boards, the printed circuit boards are arranged such that said connection portion patterns on opposing surfaces of at least one said double-sided board among said plurality of printed circuit boards are opposed to said connection portion patterns of two or more other said printed circuit boards respectively.

23. A method of manufacturing a high-frequency unit, comprising the steps of
connecting said plurality of printed circuit boards to each other by using the method of connecting printed circuit boards according to claim 14; and
arranging said plurality of printed circuit boards in a housing.

24. The method of manufacturing a high-frequency unit according to claim 23, further comprising the steps of:
forming a penetration hole in said plurality of printed circuit boards, in a portion where the printed circuit boards overlap with each other and where no said connection portion pattern is formed, at such a position that penetration holes continue to each other,
forming a board penetrating portion in said housing, and
connecting said plurality of printed circuit boards and said housing to each other by inserting said board penetrating portion in said penetration hole.

25. The method of manufacturing a high-frequency unit according to claim 24, wherein
in said step of forming a penetration hole, a ground pattern is formed in a portion where said penetration hole is formed.

26. The method of manufacturing a high-frequency unit according to claim 24, wherein
in said step of forming a board penetrating portion, a protrusion for fixation is formed at an end portion of said board penetrating portion.
